(19) United States
(12) Patent Application Publication
(10) Pub. No.: US 2003/0089552 A1
(43) Pub. Date: May 15, 2003

(54) Flexible, water-proof flashing tape

(76) Inventor: Nader F. Sahawneh, Irving, TX (US)

Correspondence Address: Thomas C. Wright, Gardere Wynne Sewell LLP, 3000 Thanksgiving Tower, 1601 Elm Street, Suite 3000, Dallas, TX, 75201-4767, US

(21) Appl. No.: 10/270,751

(22) Filed: Oct. 15, 2002

Related U.S. Application Data
(60) Provisional application No. 60/350,470, filed on Nov. 13, 2001.

(51) Int. Cl. E06C 1/38

(52) U.S. Cl. 182/1

(57) ABSTRACT

A flexible, waterproof flashing is described. The flashing contains a base layer containing at least one synthetic fiber layer and at least one metal layer; and an adhesive layer located above the base layer, wherein a portion of the adhesive layer is capable of contacting with a substrate.

This application is a conversion from and claims priority of U.S. Provisional Application Serial No. 60/350,470, filed on Nov. 13, 2001.

### TECHNICAL FIELD OF THE INVENTION

The present invention relates generally to the field of applications used in the commercial and residential construction industry, and more particularly, to flashing used to provide waterproofing barriers in structures.

### BACKGROUND OF THE INVENTION

Without limiting the scope of the present invention, its background is described in connection with various flashing materials used in the construction industry.

Various flashing materials have been used in the construction industry to seal the many joints and seams in a structure so as to prevent water from entering the structure. For example, most windows are secured in the rough opening by a nailing flange. In order to properly seal the window, various procedures have been used. Examples of various flashing installations include building a paper lapping over or under the window flange, applying flashing materials in a shingle-like fashion in the rough opening prior to window installation, applying caulking to the window flange using a caulk gun after the window is in place, and applying various flashing or adhesive tapes over the window flange. Installation is often performed from ladders or scaffolding at various levels above the ground which can lead to the material being misaligned or applied in an inconsistent manner which in turn can lead to undesirable leaks.

Various flashing materials have been used including materials made from asphalt and plastics. For example, flashing materials containing a copper sheet backed with asphalt, fabric and paper have been used in the construction industry. The flashing, however, can be relatively heavy and also is stiff and rigid, making it inconvenient to work with. Lighter weight materials such as plastics made from polyethelene and polypropylene have been used also in various flashing materials. These plastic containing flashings typically are lighter than the copper-asphalt flashings and can exhibit resistance to degradation by ultraviolet light. These materials however can be torn or punctured easily which can affect their ability to provide a good seal. Also typical flashing materials may also not be compatible with certain paints and sealants.

### SUMMARY OF THE INVENTION

What is needed is a flexible, lightweight, waterproof flashing material that exhibits enhanced tensile, tear, puncture, and seal qualities. What is also needed is a flashing material that is adhesive in nature to ease constraints associated with certain horizontal and vertical applications. Also needed is a flashing that can be utilized in a variety of locations in a construction project.

In one embodiment of the present invention, a flexible, waterproof flashing is described. The flashing contains a base layer that contains at least one synthetic fiber layer and at least one metal layer. The flashing also contains an adhesive layer located above the base layer, wherein a portion of the adhesive layer is capable of contacting with a substrate. In another embodiment of the present invention, the base layer contains a first synthetic fiber layer, a second synthetic fiber layer and a metal layer, wherein the metal layer is located between the first synthetic layer and the second synthetic fiber layer. In another embodiment of the present invention, the metal layer contains a metal selected from the group consisting of group 3-12 metals and group 13 metals. In another embodiment, the metal layer comprises aluminum. In another embodiment of the present invention, the flexible, waterproof flashing also contains a release paper attached to the adhesive layer. In another embodiment of the present invention, the synthetic fiber layer contains a nylon layer.

In another embodiment of the present invention, a flexible waterproof flashing is described containing a base layer containing a first nylon layer, a second nylon layer, and an aluminum layer. The flashing also contains an adhesive layer located above the base layer, wherein a portion of the adhesive layer is capable of contacting with a substrate. In another embodiment of the present invention, the aluminum layer is located between the first nylon layer and the second nylon layer. In another embodiment of the present invention, the second nylon layer is located in between the adhesive layer and the aluminum layer.

In another embodiment of the present invention a flashing having various characteristics is described. In another embodiment the flashing has a tensile strength in the range of from about 16 to about 19 lb per inch at break. In another embodiment, the flashing has a tear strength in the range of from about 200 to about 250 grams. In another embodiment, the flashing has a MVTR in the range of from about 0 to about 1.0 GM/100 sq in/24 hours. In another embodiment, the flashing has a puncture strength in the range of from about 8 to about 11 lbs. In another embodiment, the flashing has a seal strength in the range of from about 17 to about 18 lb/in. In another embodiment, the flashing has a gauge in the range of from about 20 to about 65 mil (and may be 25-30 mil).

In another embodiment of the present invention, a flexible waterproof flashing is described. The flashing contains a base layer containing a first nylon layer, an aluminum layer located on top of the first nylon layer, and a second nylon layer located on top of the aluminum layer. The flashing also contains an adhesive sealant layer containing a modified butyl adhesive/sealant, wherein the adhesive/sealant layer is located on top of the base layer.

In another embodiment of the present invention, a method for making a flashing tape is described. The method includes laminating a base layer containing a first nylon layer, a second nylon layer and an aluminum layer, wherein the aluminum layer is located in between the first nylon layer and the second nylon layer. The method also includes combining the base layer with an adhesive layer.

In another embodiment of the present invention, a method for making a flashing tape is described. The method includes forming a laminate of a base layer containing a first nylon layer, a second nylon layer and an aluminum layer, wherein the aluminum layer is located in between the first nylon layer and the second nylon layer. The method also includes combining the laminate with a sealant layer by extruding the sealant layer into the laminate.

### BRIEF DESCRIPTION OF THE DRAWINGS

FIG. 1 depicts a view of a flashing tape useful in the present invention.

### DETAILED DESCRIPTION OF THE INVENTION

While the making and using of various embodiments of the present invention are discussed in detail below, it should be appreciated that the present invention provides many applicable inventive concepts that may be embodied in a wide variety of contexts. The specific embodiments discussed herein are merely illustrative of specific ways to make and use the invention, and are not meant to limit the scope of the invention.

As used herein, the term membrane is used generically and refers to the material or materials contained in or upon the substance that is described as a flashing or flashing tape in the present invention. Membranes useful in the present invention may contain at least one layer, and may contain multiple layers of material. For example, membranes useful in the present invention may include one or more layers of adhesive/sealant material. Adhesive/sealants useful in the present invention may be incorporated as a layer within the membrane or may be applied as a coating to an outer surface of the membrane. According to one embodiment of the present invention, the adhesive/sealant may be extruded into one surface of the membrane, typically a surface of the membrane that is capable of contacting within a substrate, such as a window, door, or roof.

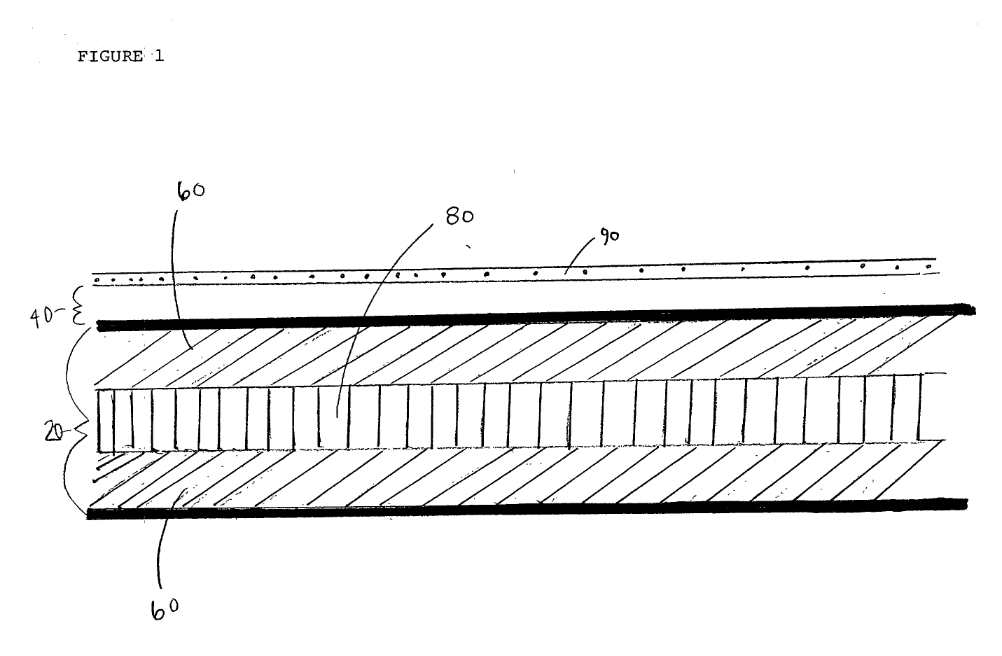

One embodiment of the present invention is shown in FIG. 1. As illustrated in FIG. 1, the flashing includes a base layer 20 and an adhesive layer 40. According to one embodiment of the present invention, the base layer 20 may be composed of multiple layers including one or more synthetic fiber layer 60 and one or more metal layer 80. In one embodiment of the present invention, as shown in FIG. 1, the metal layer 80 is between two synthetic fiber layers 60.

The synthetic fiber layer 60 may be composed of knitted fabrics made up of, synthetic fibers, such as for example, polyamide (e.g., Nylon) fibers, polyester fibers, or polypropylene fibers. These knitted fabrics have a high expandability in all directions and are well known to those skilled in the art. Various grades of nylons may be used in the present invention including but are not limited to Nylon 4, Nylon 6, Nylon 9, Nylon 11, Nylon 12, and Nylon 66. Nylons used in the present invention may be utilized in various forms, including but not limited to, mono and microfilaments, fibers, yarns, bristles, molding powders, rods, bars, sheets, and microcrystalline forms, and the like and mixtures thereof. Synthetic fiber layers of the present invention may have a thickness of up to 0.050 mm. In one embodiment of the present invention, the synthetic fiber layer has a thickness in the range of from about 0.020 mm to about 0.030 mm. In another embodiment of the present invention, the synthetic fiber layer has a thickness of 1 mil.

The metal layer 80 may contain a metal or metal alloy. Metals useful in the present invention include transition metals of Groups 3-12 of the Periodic Table of Elements, examples of which include but are not limited to copper, nickel, iron and zinc. Other metals useful in the present invention include Group 13 metals, examples of which include aluminum, gallium, indium, and thallium. In one embodiment of the present invention, the metal layer 80 includes a metal alloy that may be made of mixtures of transition and Group 13 metals, for example an alloy of aluminum and tin. In another embodiment of the present invention, the metal layer 80 is aluminum.

In general, the metal layer 80 is a thin sheet application and may serve as a reinforcing means to enhance various desired aspects of the final flashing. The metal layer 80 generally has a thickness of up to 0.120 mm. In one embodiment of the present invention, the metal layer may have a thickness in the range of from about 0.007 mm to about 0.10 mm. In another embodiment of the present invention, the metal layer has a thickness of 0.3 mm.

In one embodiment of the present invention, the adhesive layer 40 contains at least one adhesive. Generally, adhesives useful in the present invention exhibit rubbery characteristics and are capable of providing aggressive adhesion for use in horizontal and vertical applications. In addition, adhesives useful in the present invention include adhesives that are compatible with various construction sealants and primers, examples of which include but are not limited to polyurethanes, acrylics and silicone substances. The adhesive may be incorporated as a layer within the membrane or may be applied as a coating to an outer surface of the membrane. According to one embodiment of the present invention, the adhesive may be extruded into one surface of the membrane, typically a surface of the membrane that is capable of contacting within a substrate, such as a window, door, or roof.

Generally, adhesives useful in the present invention may include any material fabricated from a suitable adhesive composition that is naturally sticky or tacky at room temperature, or is a composition capable of forming an adhesive bond when the substance is combined with a catalyst or activator. Adhesives useful in the present invention include adhesives containing rubbers, examples of which include but are not limited to vulcanized or unvulcanized rubbers or reclaimed rubbers, for example, natural rubbers and synthetic rubbers, such as styrene-butadiene rubber, acrylonitrile-butadiene rubber, chloroprene rubber, butadiene rubber, isoprene rubber, butyl rubber, ethylene-propylene rubber, ethylene-propylene diene mar, polyisobutylene, chlorinated polyethylene and the like and mixtures thereof.

In one embodiment of the present invention, the adhesive/sealant is modified butyl.

Useful adhesives of the present invention include adhesives that provide low Moisture Vapor Transmission Rates or perm rates or MVTR. MVTRs typically describe the weight of water vapor allowed through a tape within a specified time period. According to one embodiment of the present invention, adhesives provide a MVTR of less than about 1.0 Gm/100 sq in/24 hours. In another embodiment of the present invention, the adhesive exhibits an MVTR in the range of from about 0.01 to about 0.30 Gm/100 sq in/24 hours. In another embodiment of the present invention, the adhesive has an MVTR of less than about 0.006 Gm/100 sq in/24 hours.

Adhesives useful in the present invention may have dimensional characteristics and may conform to the shape of the membrane. In one embodiment of the present invention the adhesive does not protrude beyond the side edge portions of the membrane and the adhesive layer may have a thickness of up to 0.062 inches. In another embodiment of the present invention, the adhesive layer has a thickness of from about 0.015 to about 0.035 inches. In one embodiment of the present invention, a release sheet 90 as shown in FIG. 1 may cover the portion of the adhesive or adhesive layer that is to be contacted with a substrate. The release sheet 90 may be any means for covering the adhesive layer and protecting it until the adhesive layer is contacted with a substrate. Examples of useful release sheets include but are not limited to suitable paper-type backing strips, or other material capable of preventing contact between the adhesive layer and the substrate. In one embodiment of the present invention, a silicon-coated paper is used to protect the adhesive surface and is removed as the product is installed.

In one embodiment of the present invention, the membrane contains a laminate containing a first nylon layer, a metal layer, and a second nylon layer. In one embodiment of the present invention, the metal layer is located between the first nylon layer and the second nylon layer. In another embodiment of the present invention, the laminate portion of the membrane may be connected to the adhesive portion due to the adhesive being extruded into the membrane or the adhesive may be applied on top of or on the surface of the portion of the membrane containing the laminate.

Nylon layers useful in the present invention may have a thickness of up to 0.050 mm. In one embodiment of the present invention, the nylon layer has a thickness in the range of from about 0.020 mm to about 0.030 mm. In another embodiment of the present invention, the nylon layer has a thickness of 1 mil.

The present invention discovered that by formulating membranes described according to the present invention, for example by utilizing a nylon/aluminum/nylon layered membrane, that the resulting flashing material exhibited enhanced tensile, tear, puncture, abrasion and seal strength characteristics as shown in the examples below. In addition, the flashing material was able to conform easily to unusual shapes and could be folded to form a water-proof end dam or rough windowsill. The flashing material exhibited a strong waterproof seal between the flashing and substrates, as well as excellent ultraviolet light resistance and remained flexible at temperatures below 0° F. (−17° C.).

The following examples are presented to further illustrate the present invention and are not to be construed as unduly limiting the scope of the present invention.

### EXAMPLES

### Example I

The adhesion and compatibility of the flashing tape of the present invention was evaluated in the following manner. A window frame was installed in a rough opening and flashing tape as described above was placed around the edges and on each side of the window substrate. Thereafter, ¼ inch beads of polyurethane, acrylic, and silicone were applied to the surface of the flashing tape. After evaluating and observing the flashing tape under various conditions, such as room temperature, and 100° F./100% humidity in both open and closed environments, there was no evidence or sign of chemical migration or degradation of the flashing tape. For example, polyurethane adhered tenaciously and failed cohesively to the flashing tape.

### Example II

In this example, various tests were performed on the film component of the present invention to illustrate physical characteristics of the film. The data collected is shown below in Table I and includes the physical property tested, the test method used, and the value and unit of measure obtained.

TABLE I

| | UNIT OF | TEST | TYPICAL |
|---|---|---|---|
| PROPERTIES | MEASURE | METHOD | VALUE |
| Tensile Strength | Lb/inch at break | ASTM D882 | 16-19 |
| Tear Strength | Grams | ASTM D1922 | 200-250 |
| MVTR | Gm/100 sq in/24 hrs | MOCON | .006 |
| O2TR* | Gm/100 sq in/24 hrs | MOCON | .006 |
| Puncture Strength | Lbs | FSTM-101C | 10 |
| Seal Strength** | Lb/in@300° F./ | ASTM D882 | 17 |
| | 20 psi/½ sec | | |
| Gauge | Mil | | 25-350 |

*O2TR or Oxygen Transmission Rate describes the weight of air allowed through a tape with known dimension within a specified time period.
**Seal Strength is measured in accordance with ASTM D882 under the following conditions (300° F., 20 psi, ½ sec).

As the data in Table I illustrate, flashings described herein provide an excellent waterproofing barrier. As described in one embodiment of the present invention, the combination of a pliable adhesive sealant with the durability of a nylon/aluminum/nylon membrane provide two strong flexible waterproofing layers. As the data in Table I illustrate, flashings of the present invention resist puncture, abrasion, tear, and other damage during installation compared to other wall flashing resources. Because of these desirable properties, flashings of the prevent invention are useful in many areas of the construction industry, including sealing the perimeters of windows and doors against moist air infiltration and water intrusion, covering below-grade concrete cracks, at roof penetrations, under exterior door sills, over deck ledger boards, at inside and outside corners of wall sheathing, under stucco shelves and parapets, around skylights, roof tops, and sealing air conditioning and heat ducts.

While this invention has been described in reference to illustrative embodiments, it is intended that the description not be construed in a limiting sense. Those of skill in the art will recognize that various modifications and combinations of the illustrative embodiments, as well as other embodiments of the invention will be apparent to those of skill in the art upon reference to the description. It is therefore intended that the appended claims encompass any such modifications or embodiments.

What is claimed is:

1. A flexible, waterproof flashing comprising:
(a) a base layer comprising at least one synthetic fiber layer and at least one metal layer; and
(b) an adhesive/sealant layer located above the base layer, wherein a portion of the adhesive layer is capable of contacting with a substrate.

2. The flashing of claim 1, wherein the base layer comprises a first synthetic fiber layer, a second synthetic fiber layer and a metal layer, wherein the metal layer is located between the first synthetic layer and the second synthetic fiber layer.

3. The flashing of claim 1, wherein the metal layer comprises a metal selected from the group consisting of group 3-12 metals and group 13 metals.

4. The flashing of claim 1, wherein the metal layer comprises a group 13 metal.

5. The flashing of claim 1, wherein the metal layer comprises aluminum.

6. The flashing of claim 1 further comprising a release paper attached to the adhesive layer.

7. The flashing of claim 1, wherein the synthetic fiber layer comprises a nylon layer.

8. A flexible, waterproof flashing comprising:
(a) a base layer comprising a first nylon layer, a second nylon layer and an aluminum layer; and
(b) an adhesive layer located above the base layer, wherein a portion of the adhesive layer is capable of contacting with a substrate.

9. The flashing of claim 8, wherein the aluminum layer is located between the first nylon layer and the second nylon layer.

10. The flashing of claim 9, wherein the second nylon layer is located in between the adhesive layer and the aluminum layer.

11. A flexible, waterproof flashing comprising:
(a) a base layer comprising a first nylon layer, an aluminum layer located on top of the first nylon layer, and a second nylon layer located on top of the aluminum layer; and
(b) a sealant layer comprising a modified butyl sealant, wherein the sealant layer is located on top of the base layer.

12. The flashing of claim 1, wherein the flashing has a tensile strength in the range of from about 16 to about 19 lb per inch at break.

13. The flashing of claim 1, wherein the flashing has a tear strength in the range of from about 200 to about 250 grams.

14. The flashing of claim 1, wherein the flashing has a MVTR in the range of from about 0 to about 1.0 GM/100 sq in/24 hours.

15. The flashing of claim 1, wherein the flashing has a puncture strength in the range of from about 8 to about 11 lbs.

16. The flashing of claim 1, wherein the flashing has a seal strength in the range of from about 17 to about 18 lb/in a 300° F./20 psi/½ sec.

17. The flashing of claim 1, wherein the flashing has a gauge in the range of from about 25 to about 35 mil.

18. A method for making a flashing tape comprising contacting an adhesive with a base layer comprising a first synthetic fiber layer, a second synthetic fiber layer and a metal layer, wherein the metal layer is located in between the first synthetic fiber layer and the second synthetic fiber layer.

19. A method for making a flashing tape comprising contacting an adhesive with a base layer comprising a first nylon layer, a second nylon layer and an aluminum layer, wherein the aluminum layer is located in between the first nylon layer and the second nylon layer.

20. The method of claim 19, wherein the contacting step comprises extruding the adhesive into the base layer.
